(19) United States
(12) Patent Application Publication
(10) Pub. No.: US 2009/0177329 A1
(43) Pub. Date: Jul. 9, 2009

(54) Hydraulic Control Scheme for Surface Maintenance Machine

(76) Inventors: Musibau Alowonle, Golden Valley, MN (US); Daniel Paul Longhenry, Bloomington, MN (US); Steven V. Feeny, Plymouth, MN (US); Daniel F. Joslin, Sartell, MN (US); Robert Erko, Apple Valley, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/201,597

(22) Filed: Aug. 29, 2008

Related U.S. Application Data
(60) Provisional application No. 60/969,479, filed on Aug. 31, 2007.

(51) Int. Cl. G05D 7/06

(52) U.S. Cl. 700/283

(57) ABSTRACT

A control system and method of use for controlling work output delivered to a floor surface by a work tool associated with a floor maintenance machine. The control system includes a hydraulic power source, a motor assembly coupled to the power source and the work tool, a pressure sensor in communication with the motor assembly, an actuator coupled to the work tool, and a controller in communication with the pressure sensor. A valve is configured to regulate the pressure provided by the power source and applied the actuator assembly. Based on a sensed pressure applied to the motor assembly, the controller causes the actuator assembly to adjust contact of the work tool with the floor surface. Work output delivered to the floor surface by the machine can be uniformly maintained during a cleaning period as the controller adjusts floor contact of the work tool via the hydraulic actuator.

### RELATED APPLICATIONS

This application claims benefit of U.S. Provisional Application No. 60/969,479, filed Aug. 31, 2007, and incorporated by reference herein.

### FIELD OF THE INVENTION

The present invention relates generally to floor maintenance or conditioning machines, and particularly those machines employing one or more floor maintenance or conditioning tools that perform tasks including scrubbing, sweeping, polishing or burnishing.

### BACKGROUND OF THE INVENTION

Surface maintenance machines that perform a single surface maintenance or surface conditioning task are well known. Surface maintenance machines are generally directed to applications such as floor surfaces, or simply floors. The term floor, as used herein, refers to any support surface, such as, among others, floors, pavements, road surfaces, ship decks, and the like.

Many floor or surface maintenance machines are constructed so as to only sweep, others to scrub, while still others to polish or burnish. Other floor maintenance machines may be configured to perform multiple types of surface maintenance tasks.

Surface maintenance machines which perform a burnishing task generally include a scheme for controlling the degree of burnishing applied to a floor surface depending upon the type of floor surface. Such machines commonly include a tool driver assembly which includes a working appliance or tool, such as a pad or brush, affixed to the driver that is rotatably driven by a driver motor. The driver assembly is selectively raised and lowered, for example by an actuator, to achieve a desired down-force or pressure against a floor surface.

Surface maintenance machines which perform a scrubbing task also commonly include a driver assembly having a rotatable scrubber, such as a brush, pad, or the like, affixed to a scrubber head rotatably driven by a driver motor. The scrubber head typically is selectively raised and lowered by an actuator coupled to the driver to achieve a desired scrubbing down-force or pressure of the brush against a floor surface. Like burnishing machines, some scrubbing machines include a scheme for controlling the scrubbing force or pressure applied to the floor surface.

Sweeper systems also are analogous to burnishing and scrubbing systems in that they too may include a rotatable sweeper tool (e.g., a brush) driven by a driver motor. Like burnishing and scrubbing systems, the sweeper system brush may be lowered and raised relative to a floor to achieve a desired sweeping result.

Schemes for controlling the burnishing/scrubbing/sweeping force typically employ an electric current sensor to monitor the current drawn by the driver motor. In such schemes, a sensed motor current may be used to control torque load on the driver motor such that a desired burnishing/scrubbing/sweeping force may be achieved. However, such schemes may not provide accurate control of the work output applied to the floor, because the voltage and amperage applied to the driver motor may vary, thus causing corresponding variations in speed and work output of the rotatable work tool.

In accordance with other control schemes, a “floor pressure” sensor is employed that provides a signal that is representative of the force of the work tool against the floor. This signal also may be used to control torque load on the motor to achieve a desired work force or output, although, again, variations in driver motor voltage are typically not taken into account.

The shortcomings of such known control schemes are particularly noticeable in floor conditioning machines that are powered by a rechargeable battery supply. Although a rechargeable battery supply offers some conveniences, the battery voltage applied to the various floor conditioning systems or appliances, and particularly to the driver motor, decays in relation to the energy discharged by the battery and the total time of discharge. Thus, the available mechanical conditioning/working power that may be delivered to the floor varies dependent upon the voltage and current that the battery supply can deliver to the driver motor. That is, mechanical working power (i.e., work output delivered to the floor) is proportional to the power delivered to the driver motor.

Thus, for example, if the driver motor current is held constant, the conditioning work delivered to the floor surface will vary as a function of voltage applied to the driver motor (e.g., the battery voltage). As a result, when the driver motor load current is held constant (as is the case with known control schemes), more working power is delivered to the working appliance (i.e., brush or pad) at the beginning of the battery life cycle, and less working power is available at the end of the battery life cycle as the battery voltage decays. Such variation in mechanical working power delivered to the floor, however, may not be desirable because it can affect the consistency of the work results, particularly when the floor conditioning task is burnishing, and, even more particularly, when the burnishing task is part of a multi-task floor conditioning machine.

### SUMMARY OF THE INVENTION

In accordance with a first aspect of the invention, a control system for controlling work output delivered to a floor surface by a work tool associated with a floor maintenance machine includes a hydraulic power source, a hydraulic motor assembly coupled to the power source and the work tool, a pressure sensor coupled between the power source and the motor assembly, an actuator assembly coupled to the work tool and coupled to the power source, and a controller in communication with the pressure sensor, the actuator assembly, and the motor assembly. A valve is configured to regulate the pressure provided by the power source and applied the actuator assembly. Based on the sensed pressure to the motor assembly, the controller generates a control signal which causes the actuator assembly to adjust contact of the work tool with the floor surface, thereby controlling work output delivered to the floor.

In accordance with another aspect of the invention, a control system for controlling work output delivered to a floor surface by a work tool associated with a floor maintenance appliance includes a hydraulic power source, a hydraulic motor coupled to the power source and the work tool, a hydraulic actuator assembly coupled to the work tool, a pressure monitor circuit configured to monitor the pressure provided by the power source to the hydraulic motor, and a controller circuit. The controller circuit is configured to generate a control signal based on the monitored motor pressure. In response to the control signal, the hydraulic actuator adjusts contact of the work tool with the floor surface as appropriate to control the work output delivered to the floor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a schematic diagram of an exemplary embodiment of a control system for a floor maintenance appliance for controlling the work output delivered to a floor surface; and

FIG. 2 is a partial schematic diagram the control system of FIG. 1 illustrating a worn pad condition and stop structure engagement.

### DETAILED DESCRIPTION OF THE INVENTION

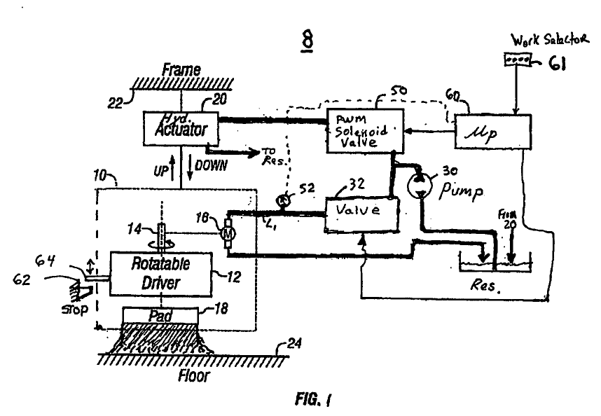

Referring first to FIG. 1, a schematic diagram is illustrated representing one exemplary embodiment of a control system for a floor maintenance machine 8 capable of controlling the work output delivered to a floor by a rotatable work tool, such as a polishing pad, a scrubber, a brush, etc. In FIG. 1, a movable tool assembly 10 is configured as a scrubbing system suspended from a frame 22 associated with floor maintenance machine 8 by way of hydraulic actuator 20. Floor maintenance machine 8 may assume a variety of configurations including, but not limited to, ride-on and walk-behind sweepers, scrubbers and burnishers.

Hydraulic actuator 20 is configured to raise and lower the maintenance device 10 relative to the floor 24. Although a floor scrubbing tool is illustrated in FIG. 1, it should be understood that the movable tool assembly 10 may be configured to perform other types of maintenance tasks, such as sweeping and burnishing, or a combination of maintenance tasks.

As shown in FIG. 1, movable tool assembly 10 includes a rotatable driver 12 having a rotatable shaft 14 coupled to a hydraulic drive motor 16. A rotatable work tool for performing the work task includes, in this example, a scrubbing pad 18 that is coupled to rotatable driver 12. The movable tool assembly 10 and the actuator 20 may be implemented by way of a wide array of components and techniques.

During operation of maintenance machine 8, hydraulic motor 16 causes the pad 18 to rotate and the hydraulic actuator 20 causes the movable tool assembly 10 to move downward so that pad 18 contacts floor 24 with a certain down-force. Further downward movement of the movable tool assembly 10 toward the floor 24 causes an increase in the amount of force transferred through pad 18 against the floor 24.

A hydraulic power source 30 provides the hydraulic power to the movable tool assembly 10 and may include an electric hydraulic pump or a PTO driven pump, for example. The power source 30 may be any type of suitable hydraulic power source for the particular maintenance machine 8. In the embodiment illustrated in FIG. 1, the power source 30 is an electric hydraulic pump. Pressurized hydraulic fluid is provided from power source 30 to motor 16 via a valve 32.

In the embodiment illustrated in FIG. 1, the work output to the floor surface 24 is controlled by adjusting the distance between movable tool assembly 10 and floor surface 24 in response to a signal (e.g., voltage) applied to the hydraulic actuator solenoid valve 50. Pressure sensor 52 is configured to monitor the hydraulic pressure applied to drive motor 16 and provides a signal representative of the sensed pressure to controller 60. Pressure sensor 52 may be configured in a wide variety of arrangements suitable to provide a signal that is representative of the pressure applied motor 16.

Controller 60 is configured to control the position of the movable tool assembly 10 relative to the floor 24 to achieve a desired work output, i.e., the amount of work (e.g., scrubbing, burnishing, sweeping) accomplished by the appliance. A work selector 61, which may be coupled to a user interface and include push buttons, multi-position switches, menu displays, etc., allows a user to manually select a desired work output setting (e.g., high, medium and low). Based on the user's selection, the work selector 61 provides the controller 60 with an input signal representative of the selected work output. By comparing the actuator pressure and the desired work output as represented by another signal (via a lookup table, etc.), controller 60 generates a pulse-width-modulated (PWM) voltage signal applied to valve 50 which causes the actuator 20 to raise or lower the assembly 10 relative to the floor surface 24, thereby controlling the level of work output.

Controller 60 may be in communication with motor valve 32. In some embodiments of the invention, valve 32 may be an electrically controllable valve such as valve 50. In other embodiments of the invention, valve 32 may be fixed in position or replace or eliminated.

Controller 60 in the control scheme illustrated in FIG. 1 can minimize variations in work output that may be caused by variations of parameters that contribute to changes in the torque through the motor 16, such as the characteristics of the floor surface (e.g., bumps, dips, tacky, slippery, etc.). Thus, the illustrated control scheme can beneficially maintain the work output at a desired level.

In some floor maintenance applications, it may be desirable to vary the work output based on certain parameters as opposed to maintaining the work output at a constant level. For example, it may be desirable to control the rotational speed of the work tool over time (and thus the work output over time) based on the status of the actuator. In another example, it may be desirable to control the down pressure of the work tool over time (and thus the work output) based on the status of the actuator or pump 30. In yet another example, a table or chart or equation may be referenced which relates tool work (either calculated directly with tool speed and torque measurements or motor current and voltage measurements) to a state of pump 30. Such a table or chart or equation (implemented in software and/or hardware) could be used to provide different operational characteristics during a machine operational session. For example, a table may be used to relate work output to pump 30 state such that as the pump charge decreases, the work output would remain constant or follow some predetermined curve (increasing or decreasing over time). Such control schemes advantageously could provide more consistent work results.

A mechanical stop structure 62 is provided on the machine frame 22 to limit the downward movement of assembly 10. A stop engagement structure 64 contacts stop 62 when movable assembly 10 has reached a lower limit of movement. Further downward movement of movable assembly 10 is thus prevented by stop structure 64.

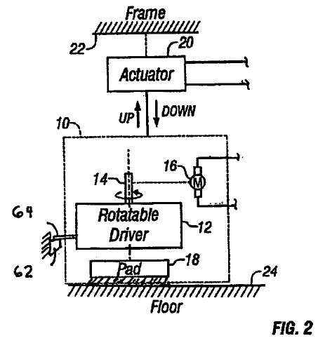

FIG. 2 illustrates movable assembly 10 in a most downward position wherein further downward movement is prevented by stop structure 64. FIG. 2 illustrates a worn condition of pad 18 as compared to pad 18 of FIG. 1. FIG. 2 represents a portion of the machine 8 of FIG. 1.

Controller 60 can indirectly evaluate a degree of brush 18 wear by monitoring motor 16 pressure sensed at pressure sensor 52. When the brush 18 is new or relatively new, an increase in the pressure applied to hydraulic actuator 20 will cause an increase in motor 16 torque (sensed by increased pressure at sensor 52). When the brush 18 is worn to an unacceptable level, stop structure 64 is engaged as the movable assembly 10 has extended to its most downward position. As stop structure 64 engages stop 62, the pressure applied to hydraulic actuator 20 will no longer influence motor 16 torque. By observing that the torque of motor 16 (as sensed by fluid pressure sensor 52) does not increase in relation to increased pressure applied by valve 50, a judgment can be made that pad 18 has worn beyond a condition of desired performance. A similar judgment can be made by installing a torque sensor on drive motor 16.

The controller 60, may be implemented in a variety of different manners, such as by discrete analog and/or digital circuitry, integrated circuits, programmable arrays, microprocessor or micro-controller based circuitry, software, firmware, etc., or any combination of the foregoing. Specific inputs that may be selected will vary, dependent upon the chosen circuit configurations and specific floor maintenance machine assembly characteristics.

In practice, it has been found that stability and reliability of the control schemes illustrated in FIGS. 1 and 2 outweigh the benefits of a control scheme that can more quickly respond to variations that cause changes in work output. For example, as the floor maintenance machine is moved over the floor 24, floor surface variations can cause temporary variations in the motor 16 torque. Because the movable assembly 10 is configured to have a certain amount of resiliency to compensate for such floor surface variations and because such variations typically are short-lived, the controller 60 need not be configured to compensate for such variations, thus simplifying the design. Accordingly, in exemplary embodiments the controller 60 is configured to respond to a variation in the monitored pressure only if the variation has persisted longer than a given amount of time.

Another advantage of a controller configuration that does not have a particularly quick response time is that movement of the assembly 10 relative to the floor 24 typically will occur infrequently.

Further, it should be understood that although the foregoing exemplary embodiments contemplate the ability to select a desired work output, in alternative embodiments, the control system, including controller 60, can be configured such that the work output is not a user-selectable parameter but rather is determined by the controller 60 based on other parameters, such as type of work tool and the task to be performed, sensed characteristics of the floor surface, etc. For example, an optical sensor may be utilized to provide floor type or condition as an input to controller 60.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A control system for controlling work output delivered to a floor surface by a rotatable work tool of a floor surface maintenance machine, the control system comprising:
a motor assembly coupled to a fluid power source and a rotatable work tool, said motor assembly configured to drive said rotatable work tool;
a hydraulic actuator coupled to the rotatable work tool and the fluid power source and configured to adjust contact of the rotatable work tool with the floor surface as the maintenance machine traverses an area to be cleaned;
a fluid regulating device coupled between the power source and the hydraulic actuator, said device configured to change a pressure supplied to the hydraulic actuator by the fluid power source; and
a pressure sensor configured to sense a pressure supplied to the motor assembly by the power source and provide a pressure signal to a controller, said controller configured to supply a control signal based at least in part on the pressure signal to the fluid regulating device, said control signal causing the actuator to raise or lower the rotatable work tool relative to the floor surface.

2. The control system of claim 1, wherein the fluid regulating device is a valve and the controller is in communication with the valve to regulate pressure applied to the motor assembly based on a control signal received from the controller.

3. The control system of claim 1, wherein the hydraulic actuator adjusts contact of the rotatable work tool with the floor surface based on the sensed pressure signal until a stop structure is engaged by the motor assembly.

4. The control system of claim 1, wherein the power source comprises a motor driven or electric hydraulic pump.

5. The control system of claim 1, further comprising:
a work selector in communication with the controller, wherein the work selector is configured to indicate a selected work output to be delivered to the work surface, and the controller is configured to cause the actuator to adjust contact of the rotatable work tool with the floor surface based on the selected work output.

6. The control system of claim 5, wherein the selected work output is determined by a user.

7. The control system of claim 6, wherein a work output delivered to the floor surface is controlled by the controller to provide a substantially uniform work output during machine operation within the area to be cleaned.

8. A control system for controlling work output delivered to a floor surface by a rotatable work tool of a floor surface maintenance machine, the control system comprising:
a hydraulically driven work tool provided in variable contact with a floor surface, said work tool being coupled to a movable tool assembly;
a hydraulic actuator coupled to the movable tool assembly and configured to adjust contact of the work tool with the floor surface as the maintenance machine traverses an area to be cleaned;
a controllable valve coupled between a power source and the hydraulic actuator, said valve configured to change a pressure supplied to the hydraulic actuator;
a pressure sensor configured to sense the pressure supplied to a work tool motor; and
a controller configured to supply a control signal to the valve based on a signal from the pressure sensor, said control signal causing the actuator to raise or lower the tool assembly relative to the floor surface to be cleaned.

9. The control system of claim 8 wherein the controllable valve includes an electrically controlled valve.

10. The control system of claim 9 wherein the controller provides a pulse-width-modulated signal to the valve.

11. The control system of claim 9 further comprising:
a work selector adapted for user interface to allow a user to select a desired work output.

12. The control system of claim 11 wherein the controller functions to maintain machine operation substantially at the desired work output during a cleaning period.

13. The control system of claim 8 further comprising:
a stop structure which prevents the movable tool assembly from further downward contact when the movable assembly engages the stop structure.

14. The control system of claim 13 wherein the controller provides a worn tool indication to the user when the movable tool assembly engages the stop structure.

15. A method of controlling work output delivered to a floor surface by a work tool and a motor assembly to drive the work tool, the method comprising:
directing a pressurized fluid from a power source on a floor maintenance machine to a hydraulic actuator, said actuator coupled to a floor maintenance tool to raise or lower the tool into contact with a floor surface to be cleaned, said directing including passing said fluid through a fluid control device capable of changing a fluid pressure;
monitoring a fluid pressure provided to a hydraulic motor driving the floor maintenance tool;
determining a desired work output to be delivered by the floor maintenance to the floor surface to be cleaned, and
applying a signal from a controller to the fluid control device so that the actuator lifts or lowers the floor maintenance tool relative to the floor surface and thereby controlling a work output delivered to the floor surface.

16. The method of claim 15, wherein said determining includes selecting a desired work output via a work selector provided to a user.

17. The method claim 16, wherein said selecting includes a user interface capable of being accessed while the machine traverses the floor surface.

18. The method of claim 17, wherein the controller functions to maintain the work output delivered to the floor surface to a substantially uniform level while the machine traverses the floor surface.

19. The method claim 15, further comprising:
establishing a worn tool condition by determining that an increase in pressure provided to the hydraulic actuator does not result in an increase in fluid pressure to the hydraulic motor.

20. The method of claim 19, wherein said determining results after a movable tool assembly engages a stop structure coupled to a frame of the floor maintenance machine, said stop structure preventing the movable tool assembly from further movement toward the floor surface.
